(19) United States
(12) Patent Application Publication
(10) Pub. No.: US 2025/0125549 A1
(43) Pub. Date: Apr. 17, 2025

(54) CONNECTOR TERMINAL, CONNECTOR, AND METHOD FOR MANUFACTURING CONNECTOR TERMINAL

(71) Applicant: Tyco Electronics (Shanghai) Co., Ltd., Shanghai (CN)

(72) Inventors: Weidong Zhang, Shanghai (CN); Daiqiong (Diana) Zhang, Shanghai (CN); Lei Pan, Shanghai (CN); Keke Gan, Shanghai (CN)

(73) Assignee: Tyco Electronics (Shanghai) Co., Ltd., Shanghai (CN)

(21) Appl. No.: 18/911,718

(22) Filed: Oct. 10, 2024

(30) Foreign Application Priority Data
Oct. 13, 2023 (CN) 202311330105.9

(51) Int. Cl. H01R 13/03; H01R 13/04; H01R 43/16

(52) U.S. Cl. CPC H01R 13/03; H01R 13/04; H01R 43/16

(57) ABSTRACT

A connector terminal includes a terminal body and an electroplated component. The electroplated component includes a substrate layer and an electroplating layer. The substrate layer has a first and second surface opposite to each other in its thickness direction, wherein the first surface of the substrate layer is attached to a local area of the terminal body. The electroplating layer which formed on the second surface of the substrate layer for electrical contact with a mating terminal.

### CROSS-REFERENCE TO RELATED APPLICATION

This application claims the benefit of Chinese Patent Application No. CN202311330105.9 filed on Oct. 13, 2023, in the State Intellectual Property Office of China, the whole disclosure of which is incorporated herein by reference.

### FIELD OF THE DISCLOSURE

The present disclosure relates to a connector terminal, a method for manufacturing the connector terminal, and a connector comprising the connector terminal.

### BACKGROUND OF THE INVENTION

In the prior art, in order to improve the electrical contact performance of the connector terminal, it is usually necessary to form an electroplating layer on the entire or local surface of the connector terminal, which can be a copper electroplating layer, a silver-electroplating layer, or a gold electroplating layer. When the connector terminal is in electrical contact with the mating connector terminal, the electroplating layer on the connector terminal is in electrical contact with the electroplating layer on the mating connector terminal, thereby improving the electrical contact performance between the connector terminal and the mating connector terminal. In the prior art, as the electroplating layer is directly formed on the connector terminal, each connector terminal needs to be separately electroplated, which greatly reduces manufacturing efficiency and increases manufacturing costs.

### SUMMARY OF THE INVENTION

According to an embodiment of the present disclosure, a connector terminal includes a terminal body and an electroplated component. The electroplated component includes a substrate layer and an electroplating layer. The substrate layer has a first and second surface opposite to each other in its thickness direction, wherein the first surface of the substrate layer is attached to a local area of the terminal body. The electroplating layer which formed on the second surface of the substrate layer for electrical contact with a mating terminal.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector terminal according to the first embodiment of the present invention;

FIG. 2 shows an illustrative exploded view of the connector terminals according to the first embodiment of the present invention;

FIG. 3 shows an illustrative view of the electrical contact between the connector terminal and the mating terminal according to the first embodiment of the present invention;

FIG. 4 shows an illustrative perspective view of a connector terminal according to a second embodiment of the present invention;

FIG. 5 shows an illustrative exploded view of the connector terminals according to the second embodiment of the present invention;

FIG. 6 shows a longitudinal sectional view of a connector terminal according to a second embodiment of the present invention;

FIG. 7 shows an illustrative perspective view of a connector terminal according to a third embodiment of the present invention;

FIG. 8 shows an illustrative exploded view of the connector terminals according to the third embodiment of the present invention;

FIG. 9 shows an illustrative perspective view of a connector terminal according to a fourth embodiment of the present invention;

FIG. 10 shows an illustrative exploded view of the connector terminals according to the fourth embodiment of the present invention;

FIG. 11 shows an illustrative perspective view of a connector terminal according to a fifth embodiment of the present invention;

FIG. 12 shows an illustrative exploded view of the connector terminals according to the fifth embodiment of the present invention;

FIG. 13 shows an illustrative perspective view of a connector terminal according to a sixth embodiment of the present invention; and

FIG. 14 shows an illustrative exploded view of the connector terminals according to the sixth embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present invention a connector terminal comprises a terminal body and an electroplated component. The electroplated component includes: a substrate layer which has a first and second surface opposite to each other in its thickness direction, wherein the first surface of the substrate layer is attached to a local area of the terminal body; and an electroplating layer which is formed on the second surface of the substrate layer for electrical contact with a mating terminal.

According to another embodiment of the present invention a connector includes a housing, and the above connector terminal which is provided in the housing.

According to another embodiment the present invention, a method for manufacturing a connector terminal includes the steps of manufacturing a terminal body and an electroplated component separately and attaching the electroplated component to a local area of the terminal body.

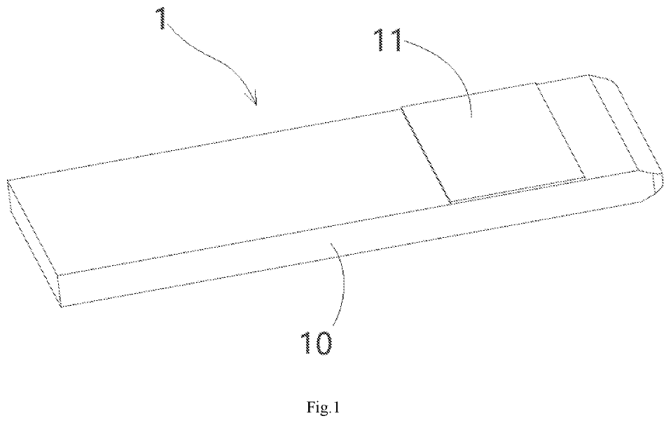

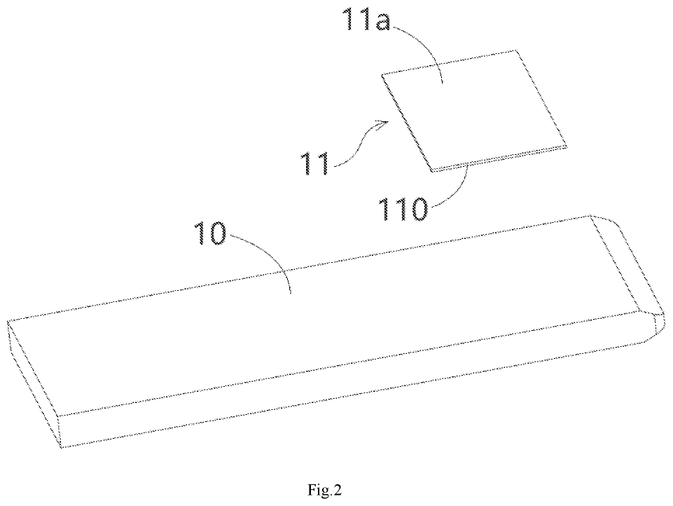

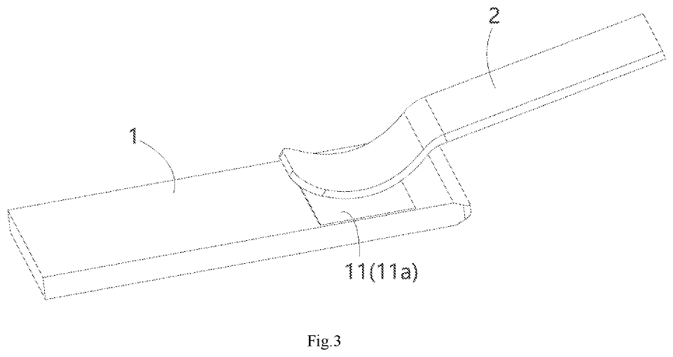

FIGS. 1 to 3 show a connector terminal 1 according to the first embodiment of the present invention. Among them, FIG. 1 shows an illustrative perspective view of connector terminal 1 according to the first embodiment of the present invention; FIG. 2 shows an illustrative exploded view of connector terminal 1 according to the first embodiment of the present invention; FIG. 3 shows an illustrative view of electrical contact between connector terminal 1 and mating terminal 2 according to the first embodiment of the present invention.

As shown in FIGS. 1 to 3, in an exemplary embodiment of the present invention, a connector terminal 1 is disclosed. The connector terminal 1 includes: a terminal body 10 and an electroplated component 11. The electroplated component 11 includes a substrate layer 110 and an electroplating layer 11a. The substrate layer 110 has a first surface and a second surface opposite to each other in its thickness direction, and the first surface of the substrate layer 110 is attached to a local area of the terminal body 10. The electroplating layer 11a is formed on the second surface of the substrate layer 110 for electrical contact with a mating terminal 2.

The conductivity of the electroplating layer 11a of the electroplated component 11 is superior to that of the substrate layer 110 of the electroplated component 11 and the terminal body 10.

The substrate layer 110 of the electroplated component 11 and the terminal body 10 may be made of the same or different materials. For example, in order to reduce manufacturing costs, the substrate layer 110 of the electroplated component 11 and the terminal body 10 can both be made of aluminum, and the electroplating layer 11a of electroplated component 11 can be a copper electroplating layer, a silver electroplating layer, or a gold electroplating layer.

The substrate layer 110 of the electroplated component 11 can be welded, riveted, or crimped onto a local area of the terminal body 10. For example, the substrate layer 110 of electroplated component 11 can be welded to a local area of the terminal body 10 using ultrasonic welding technology.

The terminal body 10 is flat and has a pair of surfaces opposite to each other in its thickness direction, and the electroplated component 11 is sheet-like and attached to the surface of the terminal body 10.

Although not illustrated, in the illustrated embodiment, a recess suitable for fitting with the electroplated component 11 can be formed on the terminal body 10, and the electroplated component 11 is embedded in the recess of the terminal body 10.

In another exemplary embodiment of the present invention, a connector is also disclosed.

The connector includes a housing (not shown) and the connector terminal 1. The connector terminal 1 is provided in the housing.

In another exemplary embodiment of the present invention, a method for manufacturing a connector terminal is also disclosed. This method mainly includes the following steps of:
S100: manufacturing a terminal body 10 and an electroplated component 11 separately; and
S200: attaching the electroplated component 11 to a local area of the terminal body 10.

As shown in FIGS. 1 to 3, in the illustrated embodiments, manufacturing the electroplated component 11 comprises the following steps of:
S110: providing a substrate plate;
S120: forming an electroplating layer 11a on one surface of the substrate plate; and
S130: stamping the substrate plate on which the electroplating layer 11a has been formed to obtain one or more electroplated component 11.

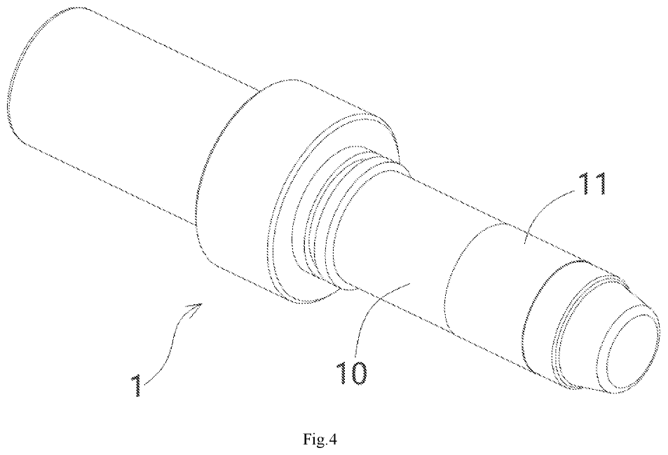

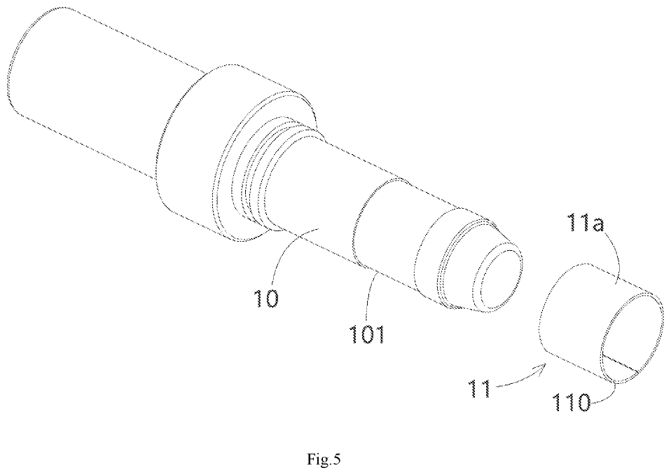

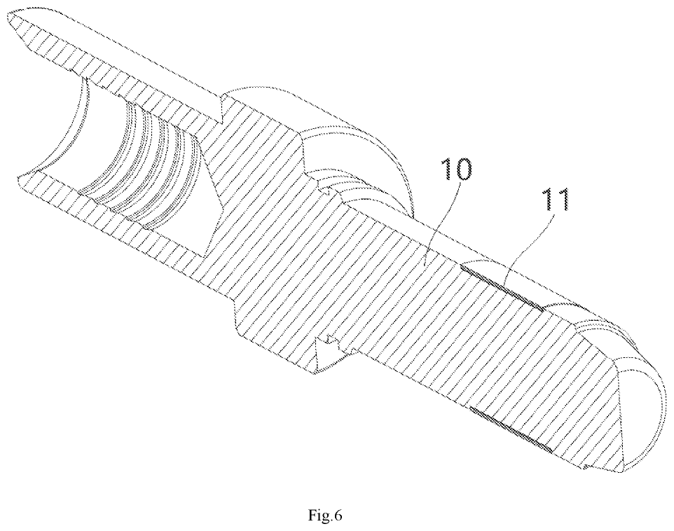

FIGS. 4 to 6 show a connector terminal according to a second embodiment of the present invention. Among them, FIG. 4 shows an illustrative perspective view of a connector terminal according to the second embodiment of the present invention; FIG. 5 shows an illustrative exploded view of the connector terminals according to the second embodiment of the present invention; FIG. 6 shows a longitudinal sectional view of a connector terminal according to a second embodiment of the present invention.

As shown in FIGS. 4 to 6, in an exemplary embodiment of the present invention, a connector terminal 1 is disclosed. The connector terminal 1 includes: a terminal body 10 and an electroplated component 11. The electroplated component 11 includes a substrate layer 110 and an electroplating layer 11a. The substrate layer 110 has a first surface and a second surface opposite to each other in its thickness direction, and the first surface of the substrate layer 110 is attached to a local area of the terminal body 10. The electroplating layer 11a is formed on the second surface of the substrate layer 110 for electrical contact with a mating terminal (not shown).

The conductivity of the electroplating layer 11a of the electroplated component 11 is superior to that of the substrate layer 110 of the electroplated component 11 and the terminal body 10.

The substrate layer 110 of the electroplated component 11 and the terminal body 10 may be made of the same or different materials. For example, in order to reduce manufacturing costs, the substrate layer 110 of the electroplated component 11 and the terminal body 10 can both be made of aluminum, and the electroplating layer 11a of the electroplated component 11 can be a copper electroplating layer, a silver electroplating layer, or a gold electroplating layer.

The substrate layer 110 of the electroplated component 11 can be welded, riveted, or crimped onto a local area of the terminal body 10. For example, the substrate layer 110 of electroplated component 11 can be welded to a local area of the terminal body 10 using ultrasonic welding technology.

The terminal body 10 is cylindrical, and the electroplated component 11 is hollow cylindrical and is mounted on the terminal body 10. The inner surface of the substrate layer 110 of the electroplated component 11 is attached to the outer surface of the terminal body 10, and the electroplating layer 11a is formed on the outer surface of the substrate layer 110 of the electroplated component 11.

A recess 101 suitable for mating with the electroplated component 11 is formed on the outer surface of the terminal body 10, and the electroplated component 11 is embedded in the recess 101 of the terminal body 10.

In another exemplary embodiment of the present invention, a connector is also disclosed.

The connector includes a housing (not shown) and the connector terminal 1. The connector terminal 1 is provided in the housing.

In another exemplary embodiment of the present invention, a method for manufacturing the connector terminal is also disclosed. This method mainly includes the following steps of:
S100: manufacturing a terminal body 10 and an electroplated component 11 separately; and
S200: attaching the electroplated component 11 to a local area of the terminal body 10.

As shown in FIGS. 4 to 6, in the illustrated embodiments, manufacturing the electroplated component 11 comprises the following steps of:
S110: providing a substrate plate;
S120: forming an electroplating layer 11a on one surface of the substrate plate; and
S130: stamping the substrate plate on which the electroplating layer 11a has been formed to obtain one or more electroplated component 11.

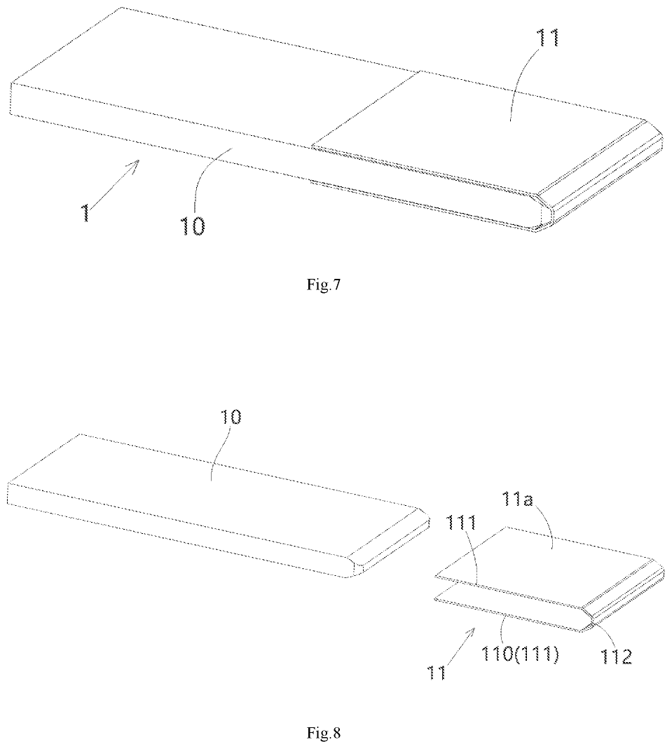

FIGS. 7 and 8 show connector terminals according to a third embodiment of the present invention. Among them, FIG. 7 shows an illustrative perspective view of a connector terminal according to the third embodiment of the present invention; FIG. 8 shows an illustrative exploded view of the connector terminals according to the third embodiment of the present invention.

As shown in FIGS. 7 and 8, in an exemplary embodiment of the present invention, a connector terminal 1 is disclosed. The connector terminal 1 includes: a terminal body 10 and an electroplated component 11. The electroplated component 11 includes a substrate layer 110 and an electroplating layer 11a. The substrate layer 110 has a first surface and a second surface opposite to each other in its thickness direction, and the first surface of the substrate layer 110 is attached to a local area of the terminal body 10. The electroplating layer 11a is formed on the second surface of the substrate layer 110 for electrical contact with a mating terminal (not shown).

The conductivity of the electroplating layer 11a of the electroplated component 11 is superior to that of the substrate layer 110 of the electroplated component 11 and the terminal body 10.

The substrate layer 110 of the electroplated component 11 and the terminal body 10 may be made of the same or different materials. For example, in order to reduce manufacturing costs, the substrate layer 110 of the electroplated component 11 and the terminal body 10 can both be made of aluminum, and the electroplating layer 11a of electroplated component 11 can be a copper electroplating layer, a silver electroplating layer, or a gold electroplating layer.

The substrate layer 110 of the electroplated component 11 can be welded, riveted, or crimped onto a local area of the terminal body 10. For example, the substrate layer 110 of electroplated component 11 can be welded to a local area of the terminal body 10 using ultrasonic welding technology.

The terminal body 10 is in a flat shape, comprising a pair of opposite surfaces in its thickness direction and two opposite ends in its longitudinal direction. The substrate layer 110 of electroplated component 11 is U-shaped, including a pair of flat plate parts 111 and a bent part 112 connected between the pair of flat plate parts 111. The electroplating layer 11a is formed on the outer surface of the substrate layer 110 of the electroplated component 11. One end of the terminal body 10 is inserted into the electroplated component 11, and the inner surfaces of the pair of flat plate parts 111 of the electroplated component 11 are respectively attached to the pair of surfaces of the terminal body 10. The inner surfaces of the bending part 112 of the electroplated component 11 are attached to an end face of the terminal body 10.

Although not illustrated, in the illustrated embodiment, a recess suitable for fitting with the electroplated component 11 can be formed on the terminal body 10, and the electroplated component 11 is embedded in the recess of the terminal body 10.

In another exemplary embodiment of the present invention, a connector is also disclosed.

The connector includes a housing (not shown) and the connector terminal 1. The connector terminal 1 is provided in the housing.

In another exemplary embodiment of the present invention, a method for manufacturing the connector terminal is also disclosed. This method mainly includes the following steps of:
S100: manufacturing a terminal body 10 and an electroplated component 11 separately; and
S200: attaching the electroplated component 11 to a local area of the terminal body 10.

As shown in FIGS. 7 and 8, in the illustrated embodiments, manufacturing the electroplated component 11 comprises the following steps of:
S110: providing a substrate plate;
S120: forming an electroplating layer 11a on one surface of the substrate plate; and
S130: stamping the substrate plate on which the electroplating layer 11a has been formed to obtain one or more electroplated component 11.

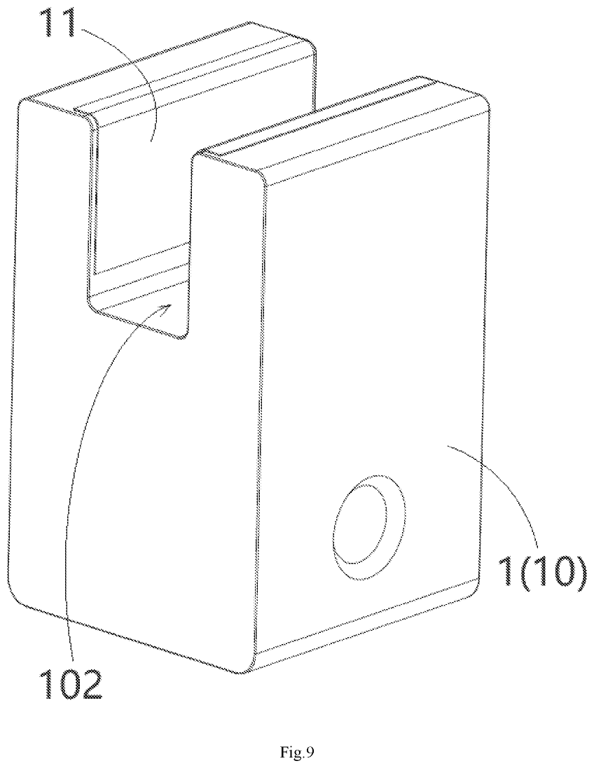

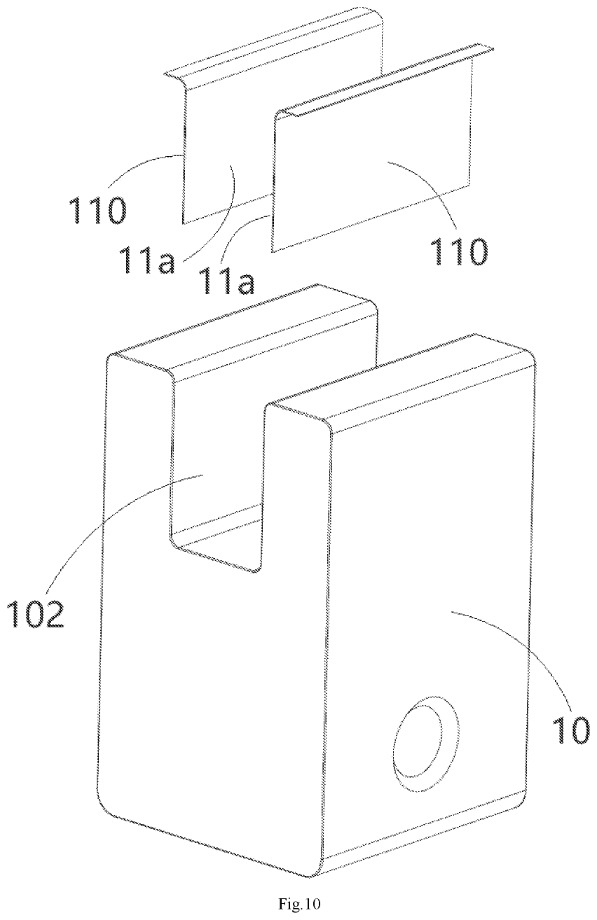

FIGS. 9 and 10 show the connector terminals according to the fourth embodiment of the present invention. Among them, FIG. 9 shows an illustrative perspective view of a connector terminal according to the fourth embodiment of the present invention; FIG. 10 shows an illustrative exploded view of the connector terminals according to the fourth embodiment of the present invention.

As shown in FIGS. 9 and 10, in an exemplary embodiment of the present invention, a connector terminal 1 is disclosed. The connector terminal 1 includes: a terminal body 10 and an electroplated component 11. The electroplated component 11 includes a substrate layer 110 and an electroplating layer 11a. The substrate layer 110 has a first surface and a second surface opposite to each other in its thickness direction, and the first surface of the substrate layer 110 is attached to a local area of the terminal body 10. The electroplating layer 11a is formed on the second surface of the substrate layer 110 for electrical contact with a mating terminal (not shown).

The conductivity of the electroplating layer 11a of the electroplated component 11 is superior to that of the substrate layer 110 of the electroplated component 11 and the terminal body 10.

The substrate layer 110 of the electroplated component 11 and the terminal body 10 may be made of the same or different materials. For example, in order to reduce manufacturing costs, the substrate layer 110 of the electroplated component 11 and the terminal body 10 can both be made of aluminum, and the electroplating layer 11a of electroplated component 11 can be a copper electroplating layer, a silver electroplating layer, or a gold electroplating layer.

The substrate layer 110 of the electroplated component 11 can be welded, riveted, or crimped onto a local area of the terminal body 10. For example, the substrate layer 110 of electroplated component 11 can be welded to a local area of the terminal body 10 using ultrasonic welding technology.

The terminal body 10 is in a block shape and formed with a slot 102 that allows for the insertion of a mating terminal (not shown), and the electroplated component 11 is in a sheet shape and attached to the inner surface of the slot 102 of the terminal body 10.

The connector terminal 1 comprises two electroplated component 11, which are respectively attached to the two inner sides of the slot 102 of the terminal body 10 to make electrical contact with both sides of the mating terminal (not shown) inserted into the slot 102.

A recess suitable for fitting with the electroplated component 11 can be formed on the terminal body 10, and the electroplated component 11 is embedded in the recess of the terminal body 10.

In another exemplary embodiment of the present invention, a connector is also disclosed.

The connector includes a housing (not shown) and the connector terminal 1. The connector terminal 1 is provided in the housing.

In another exemplary embodiment of the present invention, a method for manufacturing the connector terminal is also disclosed. This method mainly includes the following steps of:
S100: manufacturing a terminal body 10 and an electroplated component 11 separately; and
S200: attaching the electroplated component 11 to a local area of the terminal body 10.

As shown in FIGS. 9 and 10, in the illustrated embodiments, manufacturing the electroplated component 11 comprises the following steps:
S110: providing a substrate plate;
S120: forming an electroplating layer 11a on one surface of the substrate plate; and
S130: stamping the substrate plate on which the electroplating layer 11a has been formed to obtain one or more electroplated component 11.

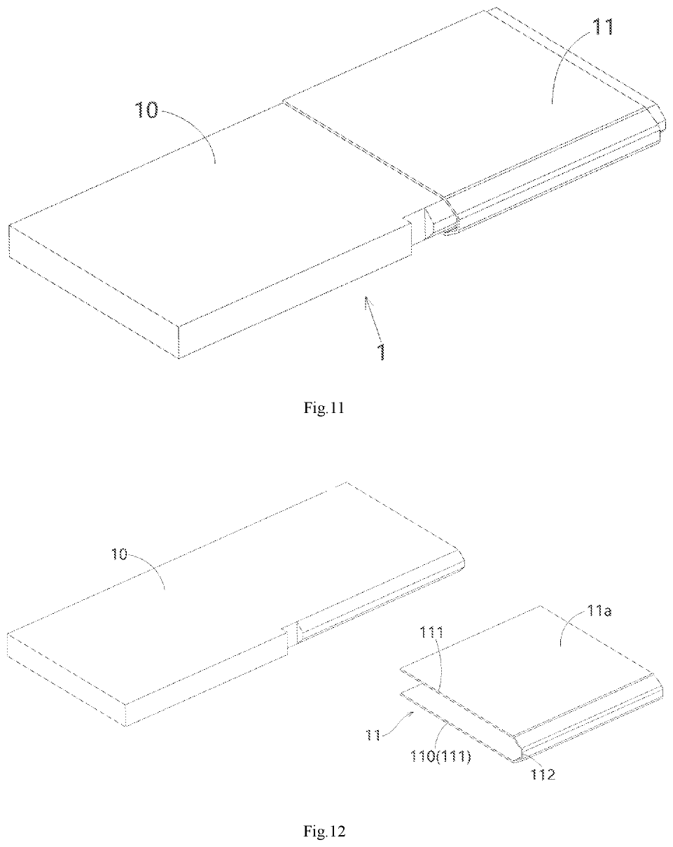

FIGS. 11 and 12 show connector terminals according to a fifth embodiment of the present invention. Among them, FIG. 11 shows an illustrative perspective view of a connector terminal according to the fifth embodiment of the present invention; FIG. 12 shows an illustrative exploded view of the connector terminals according to the fifth embodiment of the present invention.

As shown in FIGS. 11 and 12, in an exemplary embodiment of the present invention, a connector terminal 1 is disclosed. The connector terminal 1 includes: a terminal body 10 and an electroplated component 11. The electroplated component 11 includes a substrate layer 110 and an electroplating layer 11a. The substrate layer 110 has a first surface and a second surface opposite to each other in its thickness direction, and the first surface of the substrate layer 110 is attached to a local area of the terminal body 10. The electroplating layer 11a is formed on the second surface of the substrate layer 110 for electrical contact with a mating terminal (not shown).

The conductivity of the electroplating layer 11a of the electroplated component 11 is superior to that of the substrate layer 110 of the electroplated component 11 and the terminal body 10.

The substrate layer 110 of the electroplated component 11 and the terminal body 10 may be made of the same or different materials. For example, in order to reduce manufacturing costs, the substrate layer 110 of the electroplated component 11 and the terminal body 10 can both be made of aluminum, and the electroplating layer 11a of electroplated component 11 can be a copper electroplating layer, a silver electroplating layer, or a gold electroplating layer.

The substrate layer 110 of the electroplated component 11 can be welded, riveted, or crimped onto a local area of the terminal body 10. For example, the substrate layer 110 of electroplated component 11 can be welded to a local area of the terminal body 10 using ultrasonic welding technology.

The terminal body 10 is in a flat shape, comprising a pair of opposite surfaces in its thickness direction and two opposite sides in its transverse direction. The substrate layer 110 of electroplated component 11 is U-shaped, including a pair of flat plate parts 111 and a bent part 112 connected between the pair of flat plate parts 111. The electroplating layer 11a is formed on the outer surface of the substrate layer 110 of the electroplated component 11. The terminal body 10 is inserted into the electroplated component 11 along the transverse direction, and the inner surfaces of the pair of flat plate parts 111 of the electroplated component 11 are respectively attached to the pair of surfaces of the terminal body 10. The inner surfaces of the bending part 112 of the electroplated component 11 are attached to one side of the terminal body 10.

A recess suitable for fitting with the electroplated component 11 can be formed on the terminal body 10, and the electroplated component 11 is embedded in the recess of the terminal body 10.

In another exemplary embodiment of the present invention, a connector is also disclosed.

The connector includes a housing (not shown) and the connector terminal 1. The connector terminal 1 is provided in the housing.

In another exemplary embodiment of the present invention, a method for manufacturing the connector terminal is also disclosed. This method mainly includes the following steps of:
S100: manufacturing a terminal body 10 and an electroplated component 11 separately; and
S200: attaching the electroplated component 11 to a local area of terminal body 10.

As shown in FIGS. 11 and 12, in the illustrated embodiments, manufacturing the electroplated component 11 comprises the following steps of:
S110: providing a substrate plate;
S120: forming an electroplating layer 11a on one surface of the substrate plate; and
S130: stamping a substrate plate on which the electroplating layer 11a has been formed to obtain one or more electroplated component 11.

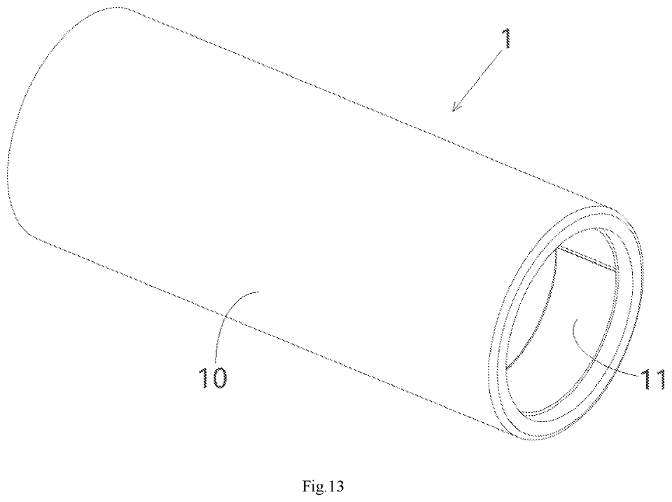

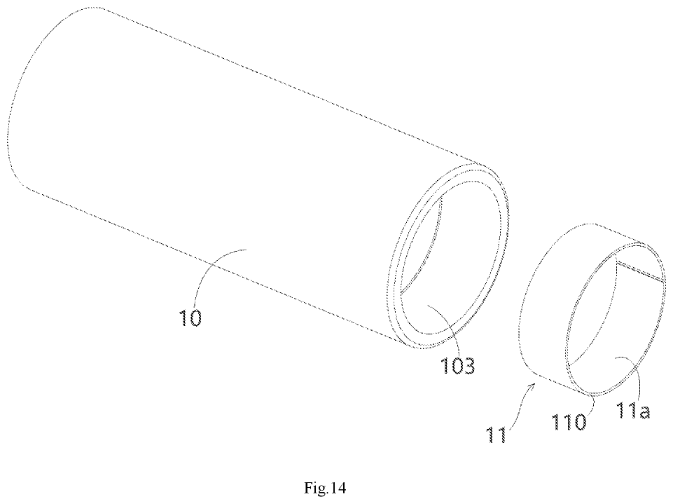

FIGS. 13 and 14 show connector terminals according to a sixth embodiment of the present invention. Among them, FIG. 13 shows an illustrative perspective view of a connector terminal according to the sixth embodiment of the present invention; FIG. 5 shows an illustrative exploded view of the connector terminals according to the sixth embodiment of the present invention.

As shown in FIGS. 13 and 14, in an exemplary embodiment of the present invention, a connector terminal 1 is disclosed. The connector terminal 1 includes: a terminal body 10 and an electroplated component 11. The electroplated component 11 includes a substrate layer 110 and an electroplating layer 11a. The substrate layer 110 has a first surface and a second surface opposite to each other in its thickness direction, and the first surface of the substrate layer 110 is attached to a local area of the terminal body 10. The electroplating layer 11a is formed on the second surface of the substrate layer 110 for electrical contact with a mating terminal (not shown).

The conductivity of the electroplating layer 11a of the electroplated component 11 is superior to that of the substrate layer 110 of the electroplated component 11 and the terminal body 10.

The substrate layer 110 of the electroplated component 11 and the terminal body 10 may be made of the same or different materials. For example, in order to reduce manufacturing costs, the substrate layer 110 of the electroplated component 11 and the terminal body 10 can both be made of aluminum, and the electroplating layer 11a of electroplated component 11 can be a copper electroplating layer, a silver electroplating layer, or a gold electroplating layer.

The substrate layer 110 of the electroplated component 11 can be welded, riveted, or crimped onto a local area of the terminal body 10. For example, the substrate layer 110 of electroplated component 11 can be welded to a local area of the terminal body 10 using ultrasonic welding technology.

The terminal body 10 is in a hollow cylindrical shape, and the electroplated component 11 is in a ring shape and inserted into the inner cavity 103 of the terminal body 10. The outer peripheral surface of the substrate layer 110 of the electroplated component 11 is attached to the inner peripheral surface of the terminal body 10, and the electroplating layer 11a is formed on the inner peripheral surface of the substrate layer 110 of the electroplated component 11.

A recess suitable for fitting with the electroplated component 11 can be formed on the inner surface of the terminal body 10, and the electroplated component 11 is embedded in the recess of the terminal body 10.

In another exemplary embodiment of the present invention, a connector is also disclosed.

The connector includes a housing (not shown) and the connector terminal 1. The connector terminal 1 is provided in the housing.

In another exemplary embodiment of the present invention, a method for manufacturing the connector terminal is also disclosed. This method mainly includes the following steps of:
S100: manufacturing a terminal body 10 and an electroplated component 11 separately; and
S200: attaching the electroplated component 11 to a local area of the terminal body 10.

Manufacturing the electroplated component 11 comprises the following steps of:
S110: providing a substrate plate;
S120: forming an electroplating layer 11a on one surface of the substrate plate; and
S130: stamping the substrate plate on which the electroplating layer 11a has been formed to obtain one or more electroplated component 11.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector terminal, comprising:
a terminal body; and
an electroplated component, including:
a substrate layer having a first and second surface opposite to each other in a thickness direction, wherein the first surface of the substrate layer is attached to a local area of the terminal body; and
an electroplating layer formed on the second surface of the substrate layer for electrical contact with a mating terminal.

2. The connector terminal according to claim 1, wherein the substrate layer of the electroplated component is welded, riveted, or crimped onto the local area of the terminal body.

3. The connector terminal according to claim 1, wherein the terminal body is flat and has a pair of surfaces opposite to each other in its thickness direction.

4. The connector terminal according to claim 3, wherein and the electroplated component is sheet-like and attached to the surface of the terminal body.

5. The connector terminal according to claim 1, wherein the terminal body is cylindrical, and the electroplated component is hollow cylindrical and is sheathed on the terminal body.

6. The connector terminal according to claim 5, wherein an inner peripheral surface of the substrate layer of the electroplated component is attached to an outer peripheral surface of the terminal body.

7. The connector terminal according to claim 6, wherein electroplating layer is formed on an outer peripheral surface of the substrate layer of the electroplated component.

8. The connector terminal according to claim 1, wherein:
the terminal body is in a hollow cylindrical shape, and the electroplated component is in a ring shape and inserted into an inner cavity of the terminal body; and
the outer peripheral surface of the substrate layer of the electroplated component is attached to an inner peripheral surface of the terminal body, and the electroplating layer is formed on an inner peripheral surface of the substrate layer of the electroplated component.

9. The connector terminal according to claim 1, wherein:
the terminal body is in a flat shape and includes a pair of surfaces opposite to each other in a thickness direction and two ends opposite to each other in a longitudinal direction; and
the substrate layer of the electroplated component is U-shaped and includes a pair of flat plate parts and a bent part connected between the pair of flat plate parts, and the electroplating layer is formed on an outer surface of the substrate layer of the electroplated component.

10. The connector terminal according to claim 9, wherein one end of the terminal body is inserted into the electroplated component, and inner surfaces of the pair of flat plate parts of the electroplated component are respectively attached to the pair of surfaces of the terminal body, an inner surface of the bent part of the electroplated component is attached to an end face of the terminal body.

11. The connector terminal according to claim 1, wherein the terminal body is in a flat shape and includes a pair of surfaces opposite to each other in a thickness direction and two opposite sides in a transverse direction.

12. The connector terminal according to claim 11, wherein the substrate layer of the electroplated component is U-shaped and includes a pair of flat plate parts and a bent part connected between the pair of flat plate parts, and the electroplating layer is formed on an outer surface of the substrate layer of the electroplated component.

13. The connector terminal according to claim 12, wherein the terminal body is inserted into the electroplated component along its transverse direction, and inner surfaces of the pair of flat plate parts of the electroplated component are respectively attached to the pair of surfaces of the terminal body, and an inner surface of the bent part of the electroplated component is attached to one side of the terminal body.

14. The connector terminal according to claim 1, wherein the terminal body is block shaped and is formed with a slot that allows for the insertion of a mating terminal, and the electroplated component is sheet shaped and attached to an inner surface of the slot of the terminal body.

15. The connector terminal according to claim 14, wherein the connector terminal includes two electroplated components respectively attached to two inner sides of the slot of the terminal body to make electrical contact with both sides of the mating terminal inserted into the slot.

16. The connector terminal according to claim 1, wherein a recess is formed on the terminal body suitable for mating with the electroplated component.

17. The connector terminal according to claim 16, wherein the electroplated component is embedded in the recess of the terminal body.

18. A connector, comprising:
a housing; and
a connector terminal provided in the housing, including:
a terminal body; and
an electroplated component, including:
a substrate layer having a first and second surface opposite to each other in a thickness direction, wherein the first surface of the substrate layer is attached to a local area of the terminal body; and
electroplating layer formed on the second surface of the substrate layer for electrical contact with a mating terminal.

19. A method for manufacturing a connector terminal comprising the steps of:
manufacturing a terminal body and an electroplated component separately; and
attaching the electroplated component to a local area of the terminal body.

20. The method according to claim 19, wherein manufacturing the electroplated component comprises the steps of:
providing a substrate plate;
forming an electroplating layer on one surface of the substrate plate; and
stamping the substrate plate on which the electroplating layer has been formed to obtain one or more electroplated component.
